(19) United States
(12) Patent Application Publication
(10) Pub. No.: US 2009/0221308 A1
(43) Pub. Date: Sep. 3, 2009

(54) System and Method for Enhancing Drug-Taking Compliance

(75) Inventors: Keith Lerner, Livingston, NJ (US); Marina T. Larson, Dillon, CO (US)

Correspondence Address: Larson & Anderson, LLC, P.O. BOX 4928, DILLON, CO, 80435, US

(73) Assignee: Novartis AG, Basel (CH)

(21) Appl. No.: 12/396,581

(22) Filed: Mar. 3, 2009

Related U.S. Application Data
(60) Provisional application No. 61/033,233, filed on Mar. 3, 2008.

(51) Int. Cl. H04W 4/00

(52) U.S. Cl. 455/466

(57) ABSTRACT

A system in the form of distributed data-processing and communications hardware components is used to enhance patient compliance with instructions for the taking of medications. The system includes a central server and a plurality of remote stations disposed at medication points-of-supply in communication for data transmission to and from the central server. Upon dispensing of a medication to a patient, the remote station transmits information to the central server and the central server receives and stores the information. The information includes at least a telephonic communication address for the patient, the nature of the medication dispensed and the amount and instructed frequency of taking the medication. The central server transmits an initial message to the patient, for example to a cellular telephone, within a pre-determined period of time following initial receipt of the information from the remote station; and subsequent messages at time intervals determined by the instructed frequency of taking the medication. Responses from the patient may be logged to confirm taking of the medication.

The application claims the benefit of U.S. Provisional Application No. 61/033,233, filed Mar. 3, 2008, which is incorporated herein by reference in its entirety.

### BACKGROUND OF THE INVENTION

This application relates to a system and method for enhancing drug-taking compliance. The system and method are suitably used for enhancing compliance with instructions for the taking of prescription medications, but may also be used with over-the-counter medications.

Compliance with the taking of medications in accordance with physician or label instructions is an essential component of obtaining the desired result from the medication. Failure to take the drug may result in decreased or no efficacy, and in some circumstances such as with antibiotics, taking of a sub-optimal dosage or a shortened period of treatment may actually result in the development of disease resistance to the drug, making it more difficult to treat the patient. In addition, lack of compliance leads to increased medical expenses, either as a consequence of treatment failure or adverse events.

Notwithstanding the importance of taking medications in accordance with a physician's instructions, the statistics relating to compliance are alarmingly poor. One survey taken in March 2005 reported that of 2507 US adults contacted, 33% of the adults who have been prescribed drugs to be taken on a regular basis report that they are often or very often non-compliant with their treatment regimens. (Harris Interactive® online survey conducted between Mar. 16 and 18, 2005 for The Wall Street Journal Online's Health Industry Edition) Within this group, of the 63% of adults who have had prescription drugs prescribed to them in the last year which are to be taken regularly, 64% reported that the reason for non-compliance was that they simply forgot to take their medication. Other reasons for non-compliance including the absence or elimination of symptoms, doubts about the effectiveness of the drug, desire to save money and side effects. See also, U.S. Pat. No. 6,150,942, which is incorporated herein by reference for a further discussion of the challenge and importance of non-compliance issues.

Factors relevant to the degree of compliance include (1) the age of the patient, with the very young, teenagers and the elderly being the least likely to comply; (2) the extent of patient support from family and friends, with people with lower levels of support being more likely to be non-compliant; (3) the quality of the patient relationship with health care providers, (4) the frequency and/or complexity of the dosing schedule and regimen; (5) the degree of education of the patient concerning the medication and the condition for which it is prescribed, and (6) cognitive impairment, either as a function of a medical condition or as a side effect from the therapy.

These statistics and the varied circumstances that can give rise to poor compliance make it clear that a need exists for an approach to enhancing compliance with drug-taking instructions. To this end, Bang & Olufsen's MEDICOM™ product provides compliance assistance for clinical trials of drugs provided in blister packs. The HELPING HAND™ product provides a carrier for blister packs that provides visual and acoustic alarms. In both cases, however, the medication must be provided in a specific format for integration with the device, and therefore is not readily adaptable to use with medications generally. Furthermore, a patient may elect not to take the device along when traveling or to work and thus the ability to provide compliance reminders at any time of the day, and on any schedule is potentially lacking. These devices also do not address many of the causes for non-compliance which are associated with a conscious decision on the part of the patient not to take the medication.

The patent literature contains many examples of methods and associated devices for enhancing compliance in taking of medications, including U.S. Pat. Nos. 4,911,327; 5,016,172; 5,710,551; 5,954,641; 6,018,289; and 6,973,371. These approaches all require special packaging of the medication, association of the medication with a device other than a pill bottle, and/or the acquisition of a special dedicated device for the purpose. They thus add to the complications and the cost associated with taking medication, and are therefore not making apparent inroads in the actual enhancement of overall patient compliance.

US Patent Publication 2008/0126130 discloses maintaining data concerning the anticipated refill date for a prescription, and whether the prescription was actually refilled. If there is no refill, a person at the pharmacy is prompted to contact the person as a reminder, and the option for storing reasons for not refilling the prescription is provided. This, does not, however, address issues of day-to-day compliance, nor provide opportunity for immediate counseling and/or intervention in the event of non-compliance.

### SUMMARY OF THE INVENTION

The present invention provides a system, in the form of distributed data-processing and communications hardware components and a method of using such a system to enhance patient compliance with instructions for the taking of medications. The system and method offer numerous advantages including:

(a) no requirement for the patient to have dedicated hardware;

(b) usefulness with any medication without regard for manufacturer or packaging format;

(c) utilizes telephonic communications, particularly cell phone communications such that it is generally accessible to the patient; and

(d) allows the opportunity for immediate counseling in the event of non-compliance based on a decision of the patient rather than simple forgetfulness.

These and other advantages are achieved using a system that comprises:

(1) a central server; and

(2) a plurality of remote stations disposed at medication points-of-supply, said remote stations being in communication for data transmission to and from the central server;

wherein upon dispensing of a medication to a patient at a point-of-supply, the remote station transmits information to the central server and the central server
receives and stores the information from a remote station, said information including at least a telephonic communication address for the patient, the nature of the medication dispensed and the amount and instructed frequency of taking the medication;
transmits an initial message to the patient via the telephonic communications address within a pre-determined period of time following initial receipt of the information from the remote station; and
transmits subsequent messages to the patient at time intervals determined by the instructed frequency of taking the medication.

In some embodiments of the invention, the messages sent by the central server are interactive messages in which a response is solicited from the patient. In this case, the central server may continue to send a particular message until such time as a positive response is received from the patient. In addition, the central server may offer the option of connection to a healthcare professional, such as a pharmacist, nurse, physician's assistant or physician in the event that the patient needs counseling about taking the medicine. In the event of failure to receive a positive response for a period of time greater than a pre-determined threshold, the central server may also send a message to the patient's personal health care provider or to a designated family member or other support person.

### BRIEF DESCRIPTION OF THE DRAWINGS

FIG. 1 shows a schematic representative of a system in accordance with the invention.

FIG. 2 shows a summary of information that may be provided by a remote location to the central server when a medication is dispensed.

FIGS. 3A and 3B shows examples of dialogs transmitted as subsequent messages by the central server in the system of the invention.

FIG. 4 shows sample screen used in conveying information about prescribed drugs.

FIG. 5 shows a series of input screens for communication between a patient and the central server concerning the taking of a medication in more detail.

FIG. 6 shows an exemplary listing of OTC medications that a patient might take in addition to prescription medications.

FIG. 7 shows an exemplary drug interaction display screen.

### DETAILED DESCRIPTION OF THE INVENTION

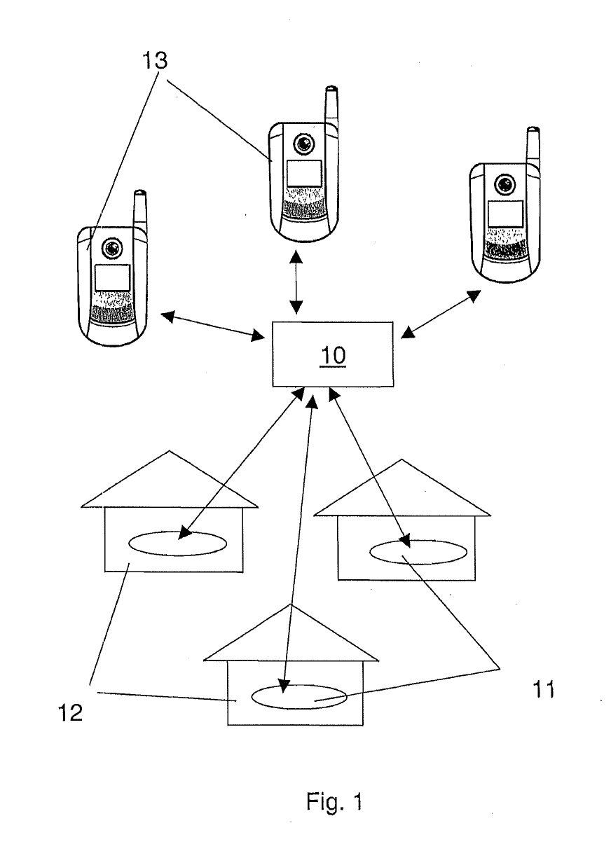

In accordance with the invention, a system is provided to assist patients to take medication correctly and on time. As depicted in FIG. 1, the system comprises a central server 10 and a plurality of remote stations 11 disposed at medication points-of-supply 12.

The central server 10 is a computer which has data processing, data storage and communications capabilities. The central server receives incoming data for the remote stations and stores is for subsequent reference and processing. The central server may also, if desired, transmit information to the remote stations. Any communications mode can be used for transmission of information between the control server and the remote stations 11, including without limitation transmission via a telephone line or transmission via a connection the Internet. The central server 10 processes the information received from the remote station 11 to identify the time for and content of messages to be sent to the patient and then communicates with the patient via a transmission to the telephonic communications address for the patient. As used in the specification and claims of this application, the term “telephonic communication” refers to a communication with a general purpose telephone, particularly a cellular telephone 13. As will be appreciated, in the case of a cellular telephone communication can be in the form of a conventional telephone call, or it can be an e-mail/text message/instant messenger communication. Thus, the term “telephonic communications address” encompasses both telephone numbers and e mail/text message/instant messenger addresses that direct communications to the telephone. Furthermore, the term “cellular phone” is used in the colloquial sense to refer to a hand held communication device, and is not intended to limit the invention to a specific for of messaging network.

The remote stations 11 are computers disposed at medication points-of-supply 12, including for example pharmacies, clinics, physician offices, hospitals and the like. These may be dedicated devices, or devices that perform other functions, in which case each remote station is effectively a distributed link into the system of the invention. Computerization of information about patients and their medications at such locations is routine to keep track of prescriptions (e.g., drug, dosage and instructions) and prescription status (e.g. last time filled and available refills), insurance information at the like. In accordance with the present invention, these systems add the capability of data transmission to and optionally from the central server.

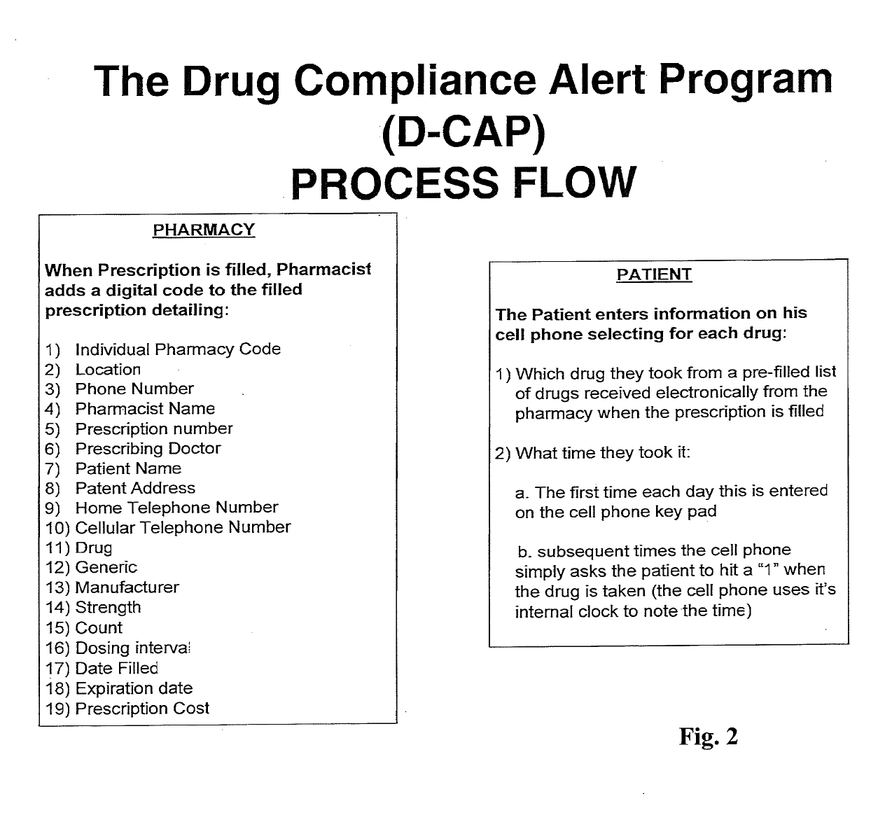

When medication is dispensed to the patient at the location of a remote station within the system, information is transmitted to the central server. This information includes at least a telephonic communication address for the patient (at least for the first transmission for a patient), the nature of the medication dispensed and the amount and instructed frequency of taking the medication. Additional information may include instructions concerning the time/circumstances for taking the medication (e.g before bedtime, with meals, on an empty stomach etc) and cautionary warnings conventionally attached to the packaging of the medication. Other information which may be transmitted is summarized in FIG. 2.

The central server receives and stores the information from the remote station, and processes the information to determine an appropriate time for transmitting an initial message to the patient via the telephonic communications address. This time period, referred to herein as a “pre-determined period of time following initial receipt of the information from the remote station” may be a fixed time, for example 30 minutes or one hour after the dispensing of the medication, or it may be a time determined based on the instructions for taking the medication. For example, in the case of a medication that is dispensed at noon but is to be taken at bed time, the predetermined time may be set for the initial message to be sent at 9 pm. If desired, patient input regarding their desired time for messages of this type may be obtained at the remote station and transmitted to the central server with the information transmission.

The central server also processes the information to determine the appropriate times to send subsequent messages to the patient at time intervals determined by the instructed frequency of taking the medication and initiates these communications via the telephonic communications address.

In preferred embodiments of the invention, the communication with the patient is interactive. For example, in the instance of an initial message, the message may ask the question, “have you taken Drug A, filled at XXX Pharmacy yet. Please press or say 1 for Yes or 2 for No.” If the answer is yes, then a further query can ask the patient to enter the time of the first dosage. From this time, the central server can then calculate the time for the next dose, and schedule the subsequent call accordingly. In addition, the central server may annunciate the time for the next dose, for example by saying “Thank you. Your next dose should be taken at 8 pm.” If the patient has not yet taken the first dose, then the central server could offer one or more of the following options: (1) an opportunity for the user to call in with the time of the first dose and information; (2) an opportunity to schedule a follow-up call at a specified time to input the information about the first dose; and (3) the opportunity to be connected to a health care professional for further consultation about the medication.

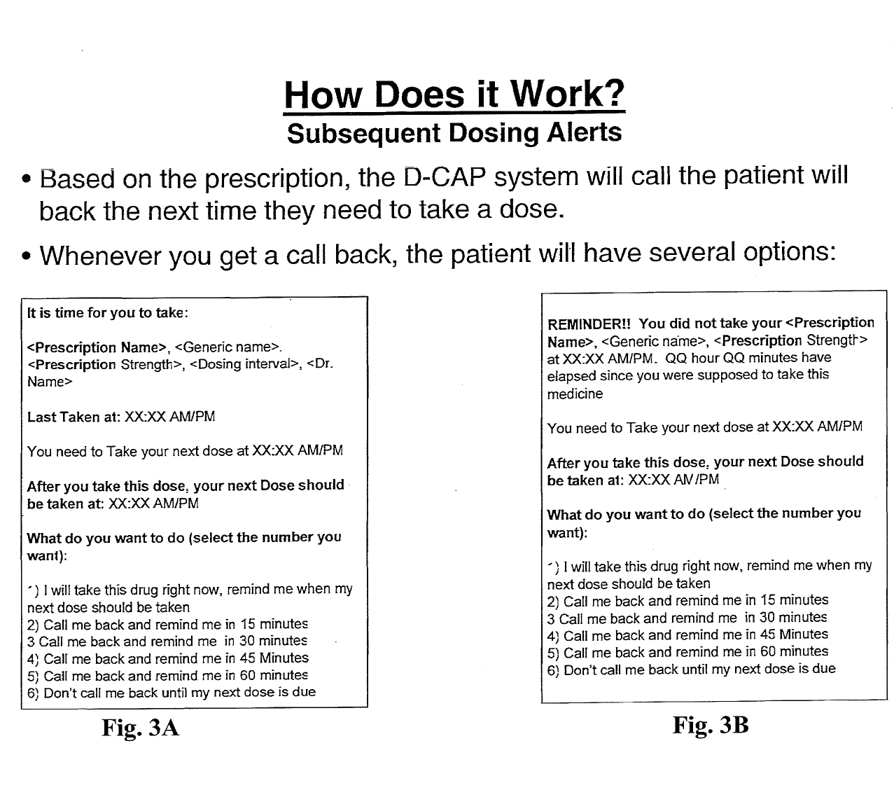

After the initial messages, subsequent messages are transmitted from the central server to the telephonic communication address at appropriate times. FIGS. 3A and B shows dialogs which might be used as a subsequent message, or as a follow-up to a subsequent message which a positive response indicating compliance has not been received at the central server.

The central server may also monitor the number of doses taken, and compare it to the number of doses dispensed, to determine an appropriate time for refill of a prescription. When this time approaches, a message may be sent to the telephone of the patient prompting them to order a refill (if available) or to contact (or to request contact from the pharmacy) their physician for a refill of the prescription. In the first instance, a transmission from the central server to a remote station places the refill order. The remote station may notify the central server when the prescription is ready for pick-up and/or when the pick-up has occurred. In some embodiments, the central server will advise the patient via the telephone when the prescription is ready for pick-up, or send a reminder to the patient if the prescription needs to be picked up to permit dosing on the correct schedule.

In some embodiments of the invention, the timing for subsequent dosages will be carried forward following pick-up of a refill prescription, rather than having a new initial call made. In the event that the refill prescription is not picked up prior to the time for the next dosage, the central server advantageously recognizes this fact and starts a new cycle with an initial message.

In some embodiments of the invention, subject to regulatory considerations, the refill order may be sent to a remote station (pharmacy) associated with the central server that is different from the one at which the prior prescription was filled. This could facilitate filling prescriptions within a chain of stores or other related remote stations when an individual is traveling. In this case, the central server may request from the patient the location at which the prescription is to be picked up. A mail order service option may also be provided. In addition, the system can identify and flag instances in which an effort is made to fill the same prescription at multiple pharmacies.

In the event that a new prescription is required from a physician, the central server may transmit a message to the physician requesting refill authorization. The authorization could be sent by the physician to the central server, in which case the central server would relay the authorization along with refill instructions to the appropriate remote station. Alternatively, the refill authorization could be sent by the physician to the remote station, in which case a notification of authorization is suitably sent from the remote station to the central server. In either case, the central server suitably monitors for the receipt of a refill authorization and sends reminders to the physician if necessary, and notifies the patient when the refill has been authorized and is available for pick-up.

Through the use of a central server collecting information about all of the medications being taken by a patient, the patient and his/her healthcare providers have available a readily accessible record of all of the drugs filled through the system and of the patient's compliance history. In some embodiments of the invention, the patient (or a healthcare provider) may call into the central server, for example using the same cellular communications device or other computer interface (i.e. Internet) to obtain information about the drugs they have prescribed. Information that may be conveyed includes:

WHAT Drugs am I taking?;

WHEN did I last tale my Prescription/OTC Drug and when do I take it next?

WHEN can I get my next refill?

HOW do I take my Drug?

HOW much did I spend this year on Prescriptions?

WHO was the Dr. that Prescribed the medicine? and

WHERE did I buy my Rx product?

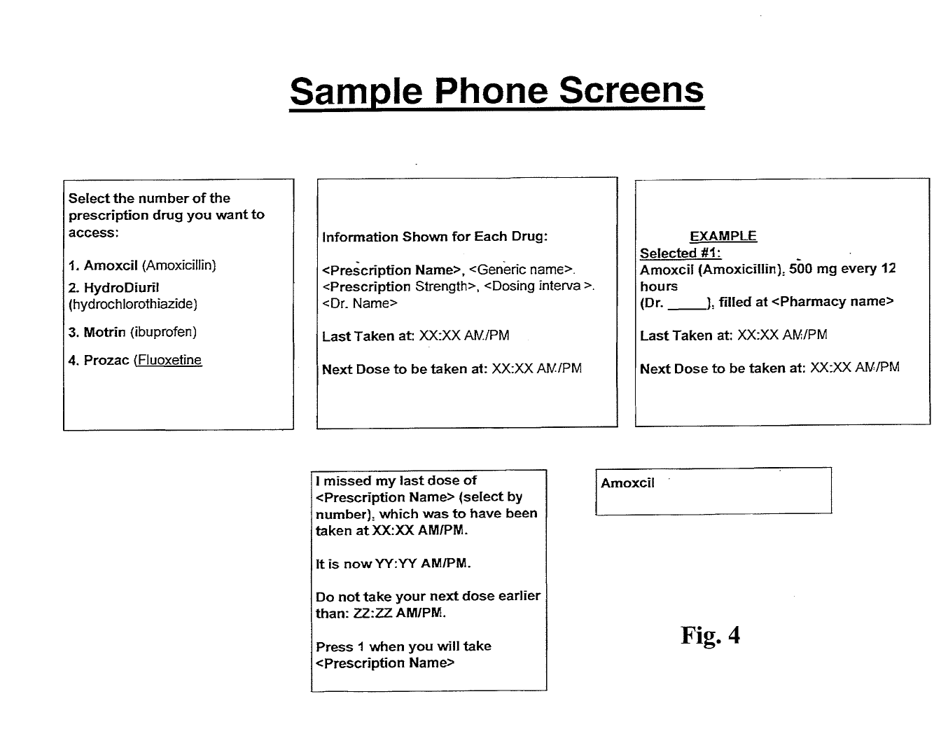

Sample screens that might be used in conveying this information are shown in FIG. 4. As shown, this type of communication also offers the option of interactive counseling about when to take a dose of a medication following a missed dosage.

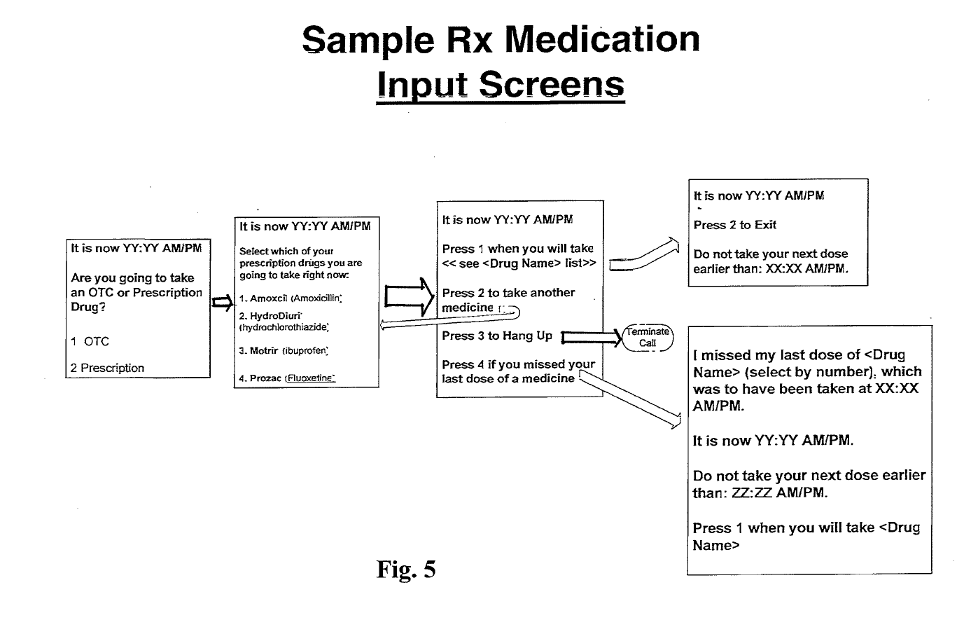

FIG. 5 shows a series of input screens for communication between a patient and the central server concerning the taking of a medication in more detail.

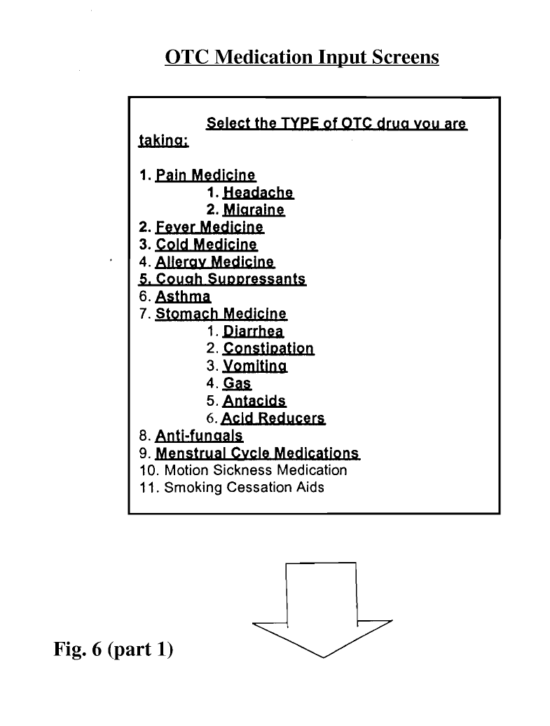

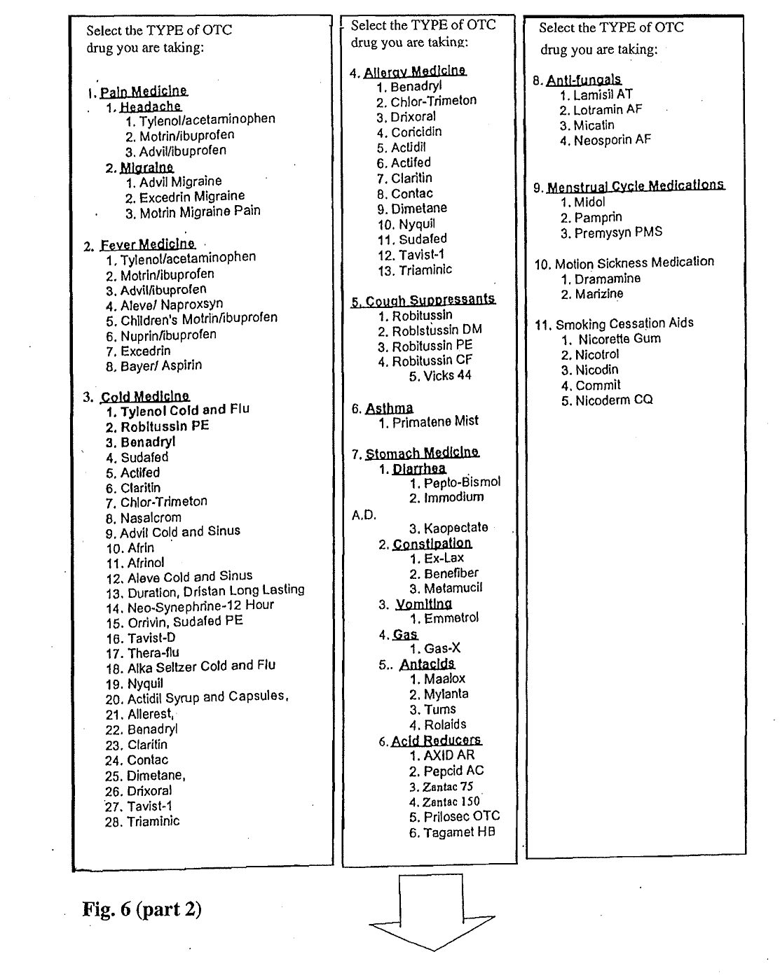

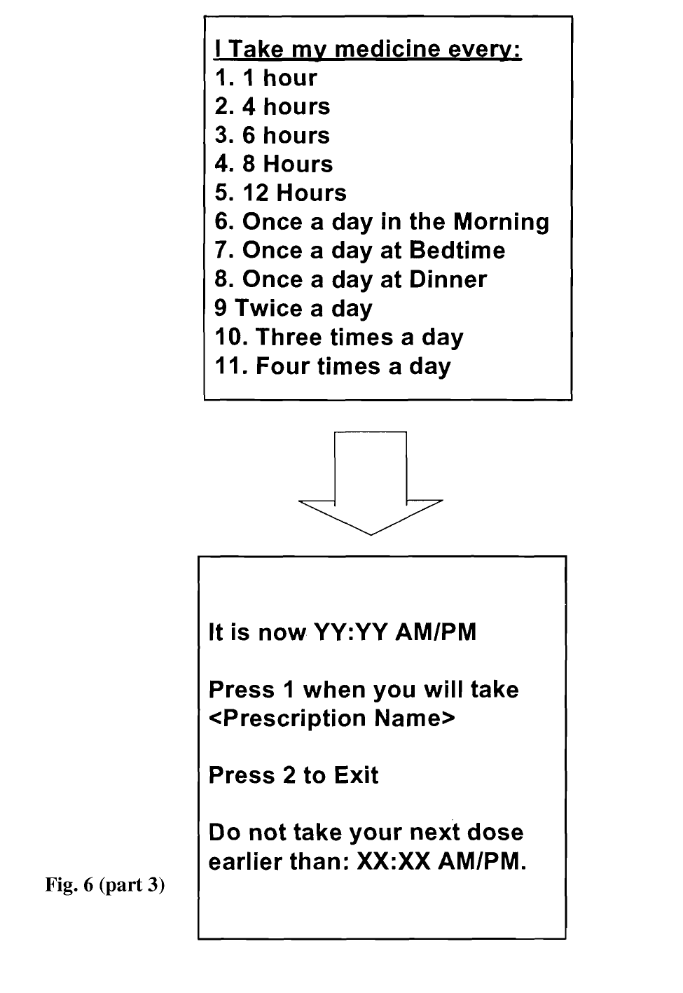

FIG. 6 shows an exemplary listing of OTC medications that a patient might take in addition to prescription medications. OTC products can be selected through an interactive screen such as this, so that reminders for the taking of the OTC medication can be added to the central server by the patient directly.

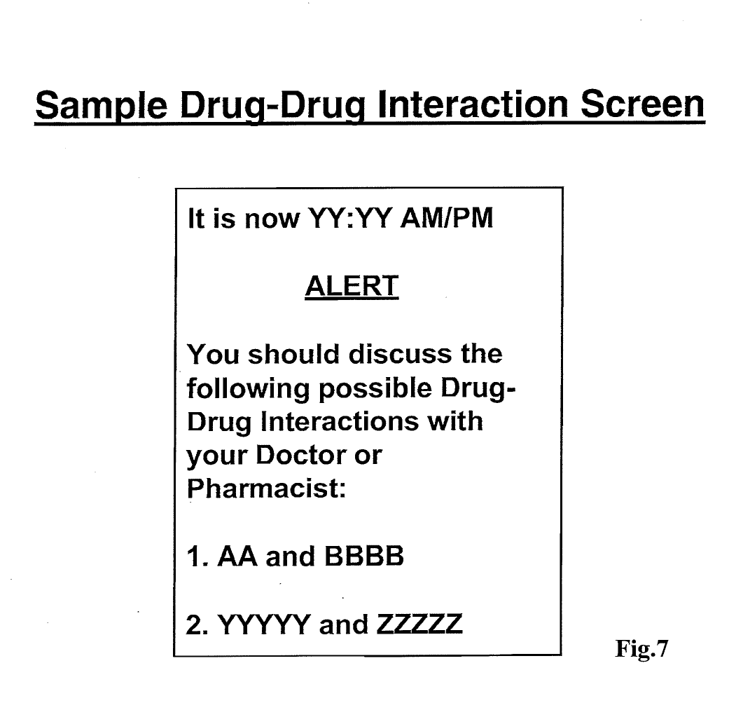

In some embodiments of the invention, the central server will access a drug interaction database to provide guidance to the patient on their cell phone about possible drug-drug interactions and/or the timing of taking prescribed medications with OTC products with which they may interact. FIG. 7 shows a sample screen in which an alert is sent to the telephone of the user to discuss possible drug interactions between two pairs of prescribed medications. This is particularly useful in the instance where a patient uses multiple physicians and potentially multiple pharmacies, provided that all of the remote stations are in a shared data system. In addition, possible conflicts with OTC medications can be brought to the attention of the patient, provided that they make use of an OTC medication entry system such as that described above.

In a further embodiment of the invention, the information stored in the central server for a patient includes emergency protocol information. Since a repeated failure to enter a response to the system may indicate a medical emergency, such a repeated failure can be used to initiate an emergency protocol, as defined by this stored information. By way of example, the emergency protocol information might include the name and contact information for a relative or physician, and a designated period of non-response that will cause the protocol to be initiated. The designated period maybe longer or shorter, depending on the severity of medical consequences that may arise as a consequence of failure to take medication on schedule.

In the instance where the communications device is a cellular telephone or similar device equipped with a position-locating device such as a GPS, part of the emergency protocol may be to obtain from the device its location. This location can then be provided as part of the emergency protocol to assist in locating the patient and providing the most immediate care if needed. If desired, storage can be provided to include the last location from which are response was received.

The system of the invention can also be used as a way to provide patient specific information to an emergency services and/or medical provider to provide information about a patient's medical history and drugs that have been taken, even when the patient is unable to provide this information. For example, a cellular communications can provide this information by way of a display, or a wireless communication (for example via Blue Tooth) in response to the entry of a query. The provided information may be stored in the cellular communications device, or transferred from the central server in response to a query.

1. A system comprising:
(1) a central server; and
(2) a plurality of remote stations disposed at medication points-of-supply, said remote stations being in communication for data transmission to the central server;
wherein upon dispensing of a medication to a patient at a point-of-supply, the remote station transmits information to the central server and the central server
receives and stores the information from a remote station, said information including at least a telephonic communication address for the patient, the nature of the medication dispensed and the amount and instructed frequency of taking the medication;
transmits an initial message to the patient via a device identified by the telephonic communications address within a predetermined period of time following initial receipt of the information from the remote station; and
transmits subsequent messages to the patient at time intervals determined by the instructed frequency of taking the medication and/or as determined by the patient.

2. The system of claim 1, wherein at least one of the remote stations is also in communication to receive data transmission from the central server.

3. The system of claim 2, wherein for at least one patient, the telephonic communication address identifies a cellular telephone for receipt of communications from the central server.

4. The system of claim 3, wherein at least some of the remote stations are located in pharmacies.

5. The system of claim 1, wherein the central server is in two-way interactive communication with at least one of the patients via devices designated by the telephonic communications addresses.

6. The system of claim 5, wherein the central server sends a query to a patient in two-way communication to confirm taking of a dosage or to schedule a follow-up reminder.

7. The system of claim 1, wherein the central server monitors the number of doses of medication taken by a patient and sends a reminder to the telephonic communications address of the patient when a refill is required.

8. The system of claim 7, wherein the central server receives from the patient a request for refill, and transmits a refill order to a remote station.

9. The system of claim 7, wherein the central server receives from the patient a request for refill, and transmits a request for refill authorization to the patient's physician.

10. The system of claim 7, wherein the central server notifies the patient when the refill is ready for pick-up at the location of the remote station.

11. The system of claim 1, wherein the patient may access the central server from the device associated with the telephonic communications address to display on the device stored information concerning the medications taken by the patient.

12. The system of claim 1, wherein the patient can identify to the central server information concerning over-the-counter medications taken by the patient, said information may access being stored on the central server,, and said central server transmitting messages concerning subsequent times for taking of the over-the-counter medications.

13. The system of claim 1, wherein the central server has access to a database of drug interactions, and provides an alert message to a patient via the device identified by the electronic communications address when the possibility of an unfavorable interaction is identified.

14. The system of claim 1, wherein the information stored on the central server for a patient includes an emergency protocol to be activated in the event of a period of non-response to messages from the central server.

15. The system of claim 1, wherein for at least one patient, the telephonic communication address identifies a cellular telephone for receipt of communications from the central server.

16. The system of claim 15, wherein the central server is in two-way interactive communication with at least one of the patients via devices designated by the telephonic communications addresses.

17. The system of claim 16, wherein the central server sends a query to a patient in two-way communication to confirm taking of a dosage or to schedule a follow-up reminder.

18. The system of claim 15, wherein the central server monitors the number of doses of medication taken by a patient and sends a reminder to the telephonic communications address of the patient when a refill is required.

19. The system of claim 18, wherein the central server receives from the patient a request for refill, and transmits a refill order to a remote station.

20. The system of claim 18, wherein the central server receives from the patient a request for refill, and transmits a request for refill authorization to the patient's physician.

21. The system of claim 18, wherein the central server notifies the patient when the refill is ready for pick-up at the location of the remote station.

22. The system of claim 15, wherein the patient may access the central server from the device associated with the telephonic communications address to display on the device stored information concerning the medications taken by the patient.

23. The system of claim 15, wherein the patient can identify to the central server information concerning over-the-counter medications taken by the patient, said information may access being stored on the central server, and said central server transmitting messages concerning subsequent times for taking of the over-the-counter medications.

24. The system of claim 15, wherein the central server has access to a database of drug interactions, and provides an alert message to a patient via the device identified by the electronic communications address when the possibility of an unfavorable interaction is identified.

25. The system of claim 15, wherein the information stored on the central server for a patient includes an emergency protocol to be activated in the event of a period of non-response to messages from the central server.

26. A method for enhancing patient compliance in the taking of medications comprising the steps of
(1) inputting patient prescription information into a system comprising:
(a) a central server; and
(b) a plurality of remote stations disposed at medication points-of-supply, said remote stations being in communication for data transmission to the central server;
wherein upon dispensing of a medication to a patient at a point-of-supply, the remote station transmits information to the central server and the central server
receives and stores the information from a remote station, said information including at least a telephonic communication address for the patient, the nature. of the medication dispensed and the amount and instructed frequency of taking the medication;
transmits an initial message to the patient via a device identified by the telephonic communications address within a pre-determined period of time following initial receipt of the information from the remote station; and
transmits subsequent messages to the patient at time intervals determined by the instructed frequency of taking the medication and/or as determined by the patient, wherein the device is a cellular telephone; and
(2) transmitting messages to and optionally from the patient via the cellular telephone.
